(19) United States
(12) Patent Application Publication
(10) Pub. No.: US 2026/0017565 A1
(43) Pub. Date: Jan. 15, 2026

(54) COMPUTER SYSTEM AND MODEL TRAINING METHOD

(71) Applicant: Hitachi, Ltd., Tokyo (JP)

(72) Inventors: Masahiro OGINO, Tokyo (JP); Zisheng LI, Tokyo (JP)

(21) Appl. No.: 18/994,239

(22) PCT Filed: Jan. 20, 2023
(86) PCT No.: PCT/JP2023/001800

§ 371 Date: Jan. 14, 2025

(30) Foreign Application Priority Data
Sep. 22, 2022 (JP) 2022-151780

(51) Int. Cl. G06N 20/00

(52) U.S. Cl. CPC G06N 20/00

(57) ABSTRACT

A system manages a first model that solves one or more tasks, and a second model that generates replay input data that is reproduction of input data included in training data used in training with a past task. The system generates replay training data using the first model and the second model, upon receiving new training data; executes a training process for updating the first model using the new training data and the replay training data; calculates an index representing uncertainty of the replay input data based on an output obtained by inputting the replay input data to the updated first model; selects the replay training data to be used for training based on the index; and executes the training process using the new training data and the selected replay training data.

### INCORPORATION BY REFERENCE

This application claims priority to Japanese Patent Application No. 2022-151780 filed on Sep. 22, 2022, the contents of which are incorporated herein by reference.

### TECHNICAL FIELD

The present invention relates to a continuous training technique for generation of a model for solving a plurality of tasks.

### BACKGROUND ART

Having been developed are systems and services that uses models generated through machine learning to solve various tasks such as predictions and classifications. There are known training methods for reusing an existing model to generate a model for handling new tasks. However, such training methods are known to have a problem referred to as catastrophic forgetting, which is a loss of results of training with tasks in the past.

As a method for generating a model enabled to handle new tasks by incorporating the training results with the past tasks, the technique disclosed in NPL 1 is known.

NPL 1 describes continuous training that uses a scalar that includes a generator for generating input data corresponding to the tasks learned in the past, and a solver for solving the tasks learned in the past, and new tasks.

### CITATION LIST

### Non Patent Literature

NPL 1: Hanul Shin, Jung Kwon Lee, Jaehong Kim, Jiwon Kim, “Continual Learning with Deep Generative Replay”, May 24, 2017
NPL 2: Yarin Gal, Zoubin Ghahramani, “Dropout as a Bayesian Approximation: Representing Model Uncertainty in Deep Learning”, Jun. 6, 2015

### SUMMARY OF THE INVENTION

### Technical Problem

According to NPL 1, no consideration is given to the reliability of data generated by the generator. The present invention implements a system and a method for implementing continuous training giving a consideration to the reliability of data generated by the generator.

### Solution to Problem

A representative example of the invention disclosed in the present application is as follows. That is, a computer system includes a computer that includes a processor, a storage device connected to the processor, and a connection interface connected to the processor, in which: the computer system is configured to manage a first model that solves one or more tasks, and a second model that generates replay input data that is reproduction of input date included in training data used in training with a past task, and the computer is configured to: generate replay input data using the second model, upon receiving new training data that includes new input data and new ground-truth data related to a new task;
generate replay training data including the replay input data and ground-truth data that is obtained by inputting the replay input data to the first model; execute first training processing for updating the first model that is current to the first model adapted to solve the new task and the past task, using the new training data and the replay training data; calculate an index representing uncertainty of data input to the first model based on an output obtained by inputting the replay input data to the first model resultant of updating; select the replay training data to be used for training based on the index corresponding to the replay input data; execute the first training process using the new training data and the replay training data having been selected; and execute second training processing for updating the second model that is current to the second model enabled to generate replay input data that is reproductions of the new input data and the selected replay input data, using the new input data included in the new training data and the replay input data included in the selected replay training data.

### Advantageous Effects of Invention

According to the present invention, it is possible to implement continuous training giving a consideration to the reliability of data generated by a generator. In this manner, the accuracy of models can be improved. Problems, configurations, and advantageous effects other than those explained above will become clear in the following description of the embodiments.

### BRIEF DESCRIPTION OF DRAWINGS

FIG. 1 is a diagram illustrating an example of a configuration of a computer according to a first embodiment.

FIG. 2 is a diagram for explaining a method for training a model in the computer, according to the first embodiment.

FIG. 3 is a diagram illustrating the sequence of training of a solver according to the first embodiment.

FIG. 4 is a flowchart for explaining an example of a process of training a solver in the computer according to the first embodiment.

FIG. 5 is a diagram illustrating the sequence of training of a generator according to the first embodiment.

FIG. 6 is a flowchart for explaining an example of training process of training a generator in the computer according to the first embodiment.

FIG. 7 is a diagram illustrating a method of training a generator according to the first embodiment.

FIG. 8 is a flowchart for explaining an example of a process of training a solver in a computer according to a second embodiment.

FIG. 9 is a diagram illustrating an example of a screen presented by the computer according to the second embodiment.

### DESCRIPTION OF EMBODIMENTS

Some embodiments of the present invention will now be explained with reference to some drawings. However, the present invention is not to be construed as being limited to the description of the following embodiment. Those skilled in the art can easily understand that specific configurations may be modified without departing from the spirit or gist of the present invention.

In the configurations according to the invention described below, the same or similar configurations or functions are denoted by the same reference numerals, and redundant descriptions thereof will be omitted.

Notations such as “first”, “second”, and “third” in the description herein and the like are given for the purpose of identifying the components, and are not necessarily limiting of the number or order.

The position, the size, the shape, the range, and the like of each configuration illustrated in the drawings and the like may be represented differently from the actual position, size, shape, range, and the like, to facilitate understanding of the invention. Therefore, the present invention is not limited to the position, the size, the shape, the range, and the like disclosed in the drawings and the like.

### First Embodiment

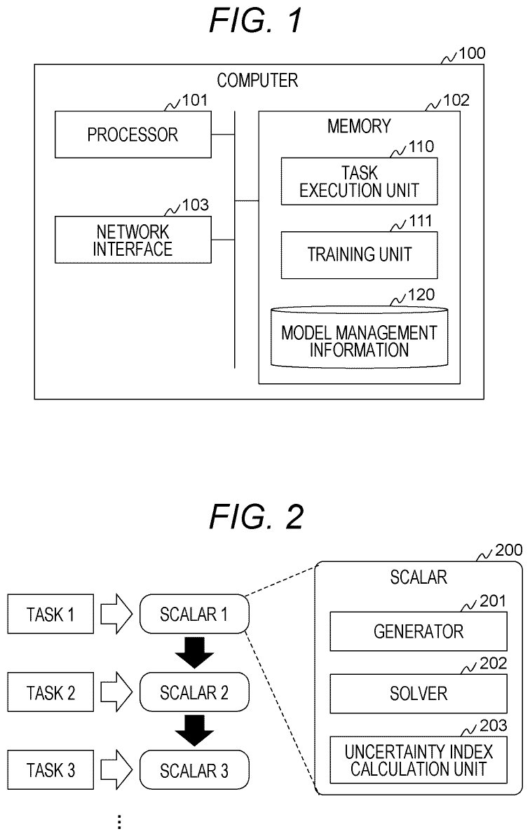

FIG. 1 is a diagram illustrating an example of a configuration of a computer 100 according to a first embodiment.

The computer 100 includes a processor 101, a memory 102, and a network interface 103. These hardware elements are connected to each other via an internal bus. The computer 100 may also include an input device such as a keyboard, a mouse, and a touch panel, and an output device such as a display.

The memory 102 stores therein a program executed by the processor 101, and information used by the program. The memory 102 is also used as a working area where data is temporarily stored.

The processor 101 executes a program stored in the memory 102. By executing processing in accordance with the program, the processor 101 operates as a functional unit (module) implementing a specific function. In the following description, when some functional unit is used a subject of a sentence describing some processing, it means that the processor 101 is executing a program implementing the functional unit.

The network interface 103 communicates with external via a network such as a wide area network (WAN) and a local area network (LAN).

The memory 102 according to the first embodiment stores therein a program for implementing a task execution unit 110 and the training unit 111. The memory 102 retains model management information 120.

The model management information 120 stores therein model information for managing a model for solving a task. The model information includes information such as a structure of the model and hyperparameters.

The task execution unit 110 executes processing for solving one or more tasks using a model managed by the model management information 120. For example, the task execution unit 110 executes processing such as event prediction and data classification. The present invention is not limited to a specific type of tasks to be executed. The present invention is neither limited to a particular number of tasks to be executed.

For example, the task execution unit 110 outputs, from an X-ray image, conditions of tissues, the presence or absence of a lesion, contrast, an imaging angle, and the like. In such a case, each of these outputs of tissue conditions, the presence or absence of a lesion, contrast, an imaging angle, and the like corresponds to a single task.

The training unit 111 executes training processing for generating a model to be used by the task execution unit 110.

FIG. 2 is a diagram for explaining a method for training a model in the computer 100 according to the first embodiment.

The training unit 111 performs training using a scalar 200 including a generator 201, a solver 202, and an uncertainty index calculation unit 203.

The generator 201 is a model configured to generate replay input data that is reproduction of input data corresponding to all tasks having learned up to that point in time. The solver 202 is a model that solves all tasks having learned up to that point in time. The uncertainty index calculation unit 203 is a functional unit that calculates an index indicating uncertainty of the replay input data.

When an input of training data corresponding to a task 1 is received, the training unit 111 trains the generator 201 for generating replay input data that is the reproduction of input data included in the training data corresponding to the task 1. The training unit 111 also trains the solver 202 for solving the task 1, with the training data corresponding to the task 1.

When an input of training data corresponding to a task k is received (where k is an integer of two or more), the training unit 111 trains the generator 201 for generating replay input data that is the reproduction of input data corresponding to the task k, from the task 1, using a scalar (k−1) obtained as a result of training processing corresponding to a task (k−1) and input data included in the training data. The training unit 111 also trains the solver 202 for solving the task k from the task 1, with the training data corresponding to the task k, and the training data generated by using the scalar (k−1).

The model management information 120 stores therein model information corresponding to the generator 201 (see FIG. 2) and the solver 202 (see FIG. 2) of a scalar 200 generated as a result of training with each task.

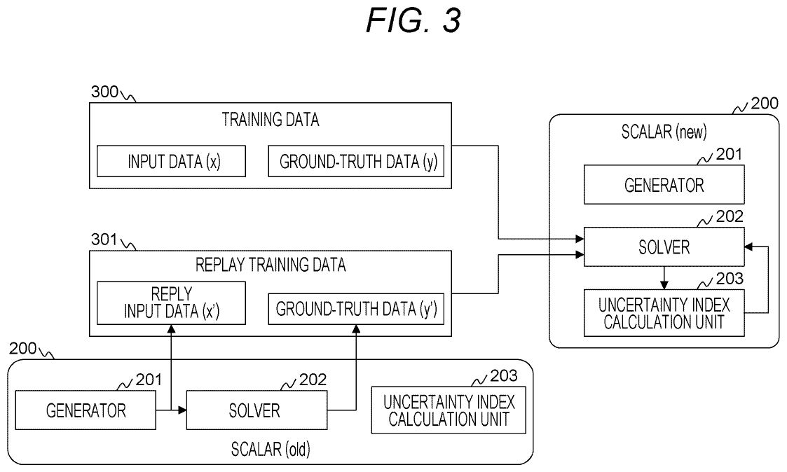

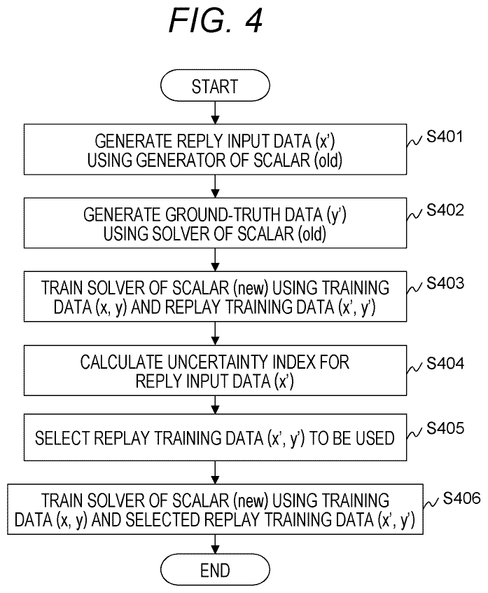

FIG. 3 is a diagram illustrating the sequence of training of the solver 202 according to the first embodiment. FIG. 4 is a flowchart for explaining an example of the process of training the solver 202 in the computer 100 according to the first embodiment.

In the description hereunder, a scalar 200 obtained as a result of the training processing up to that point in time will be denoted as a scalar (old) 200, and a scalar 200 corresponding to a new task will be denoted as a scalar (new) 200. Training data 300 is training data corresponding to the new task, and includes input data (x) and ground-truth data (y).

The training unit 111 generates replay input data (x′) using the generator 201 included the scalar (old) 200 (step S401).

The training unit 111 generates ground-truth data (y′) by inputting the resultant replay input data (x′) to the solver 202 included in the scalar (old) 200 (step S402).

The training unit 111 then trains the solver 202 included in the scalar (new) 200, using the training data 300 and replay training data 301 including the replay input data (x′) and the ground-truth data (y′) (step S403).

The training unit 111 then calculates an uncertainty index for the replay input data (x′) (step S404). Specifically, the training unit 111 inputs the replay input data (x′) included in the replay training data 301 to the solver 202 in the scalar (new) 200. The training unit 111 the calculates the uncertainty index for the replay input data (x′) by inputting the output from the solver 202 to the uncertainty index calculation unit 203.

Uncertainty of data in machine learning is also referred to as aleatoric uncertainty. Such an index can be calculated using the Monte Carlo dropout described in NPL 2. In the Monte Carlo dropout, inference is made a plurality of times by randomly setting zero to a weight of a model. In this manner, uncertainty of the inferences can be obtained. Furthermore, uncertainty of the model and uncertainty of data can be quantified by calculating a histogram, an average, entropy, variance, or the like of a distribution of the inferences. Note that the method for calculating uncertainty of data is not limited to any particular method.

The training unit 111 selects replay training data 301 to be used, on the basis of the uncertainty index of the replay input data (x′) (step S405). For example, the training unit 111 selects replay training data 301 including replay input data (x′) having an index smaller than a threshold (low uncertainty). It is assumed herein that the threshold is set in advance.

The training unit 111 trains the solver 202 in the scalar (new) 200 using the training data 300 and the selected replay training data 301 (step S406). The solver 202 is trained using a known training method. The method for training the solver 202 is not limited to any particular method.

Note that the training unit 111 may be configured to calculate the uncertainty index for the input data (x) included in the training data 300. In the first embodiment, accuracy of the solver 202 and the generator 201 is improved by selecting the training data 300 to be used in the training, on the basis of the uncertainty index of the input data (x).

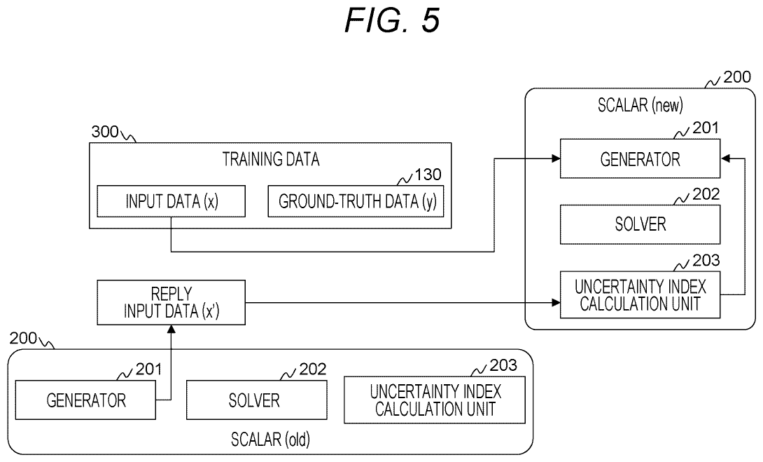

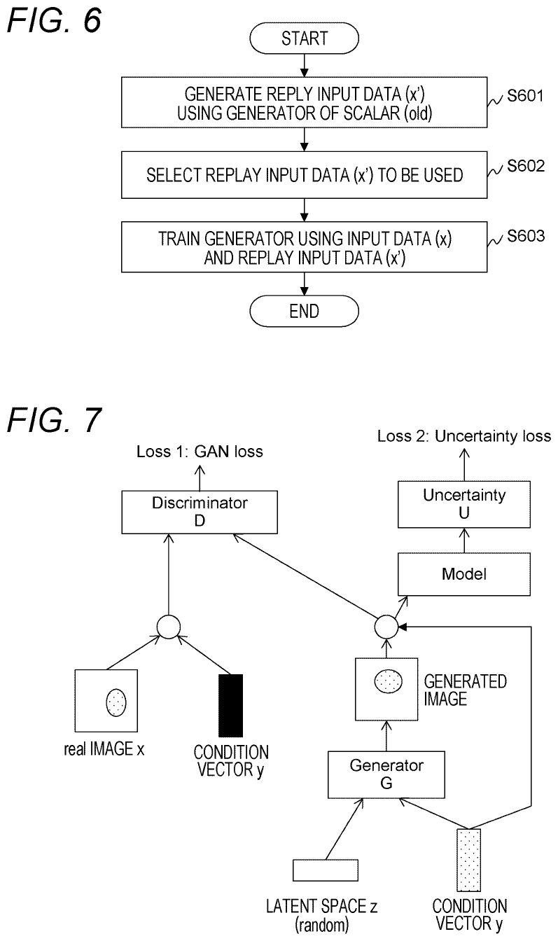

FIG. 5 is a diagram illustrating the sequence of training of the generator 201 according to the first embodiment. FIG. 6 is a flowchart illustrating an example of the process of training the generator 201 in the computer 100 according to the first embodiment. FIG. 7 is a diagram illustrating a method of training the generator 201 according to the first embodiment.

After the completion of the processing of training the solver 202, the training unit 111 starts processing of training the generator 201.

The training unit 111 generates replay input data (x′) using the generator 201 of the scalar (old) 200 (step S601).

The training unit 111 selects the replay input data (x′) to be used, on the basis of the uncertainty index of the replay input data (x′) (step S602). The processing in step S602 is executed using the result of the processing in step S405.

The training unit 111 trains the generator 201 using the input data (x) and the selected replay input data (x′) (step S603).

For the training, a conditional generative adversarial network (CGAN) is used. As illustrated in FIG. 7, in the CGAN, a discriminator and a generator is trained using input data and a condition vector (label) as inputs. The “Model” illustrated in FIG. 7 corresponds to the solver 202 according to the first embodiment.

For example, the generator 201 is trained using a loss function of Equation (1). Where D(x|y) denotes a score when a real image and a condition vector are input to the discriminator; and D(G(x|y)) denotes a score when an image generated by the generator and the condition vector are input to the discriminator. σ denotes a weight coefficient, and U denotes the uncertainty index calculated by the uncertainty index calculation unit 203. z denotes a latent variable for generating an image.

$$\begin{matrix}[ Equation 1 ] & \\ Loss = {max}_{D} {min}_{G , U} log ( D ( x \vert y ) ) + log ( 1 - D ( G ( z \vert y ) ) ) + σ ( U ) & ( 1 )\end{matrix}$$

The first and second terms correspond to Loss 1, and the third term corresponds to Loss 2. As indicated in Equation (1), the first embodiment is characterized in having an additional term for giving a consideration to the uncertainty index calculated on the basis of the output of the solver 202.

According to the first embodiment, by selecting the replay input data (x′) to be used in the training of the generator 201 on the basis of the uncertainty of the replay input data (x′), it is possible to improve the accuracy of the replay input data (x′) generated by the generator 201. Furthermore, similarly, by selecting the replay training data 301 to be used in the training of the solver 202, it is possible to improve the accuracy of the solver 202.

Note that the task execution unit 110 and the training unit 111 may be implemented using a computer system including a plurality of computers 100. Furthermore, the model management information 120 may be stored in an external system.

### Second Embodiment

A computer 100 according to a second embodiment receives a correction for the replay input data (x′) and the ground-truth data (y′) included in the replay training data 301, before the generator 201 and the solver 202 are trained. The second embodiment will now be described focusing on the difference with respect to the first embodiment.

A hardware configuration and a software configuration of the computer 100 according to the second embodiment are the same as those according to the first embodiment.

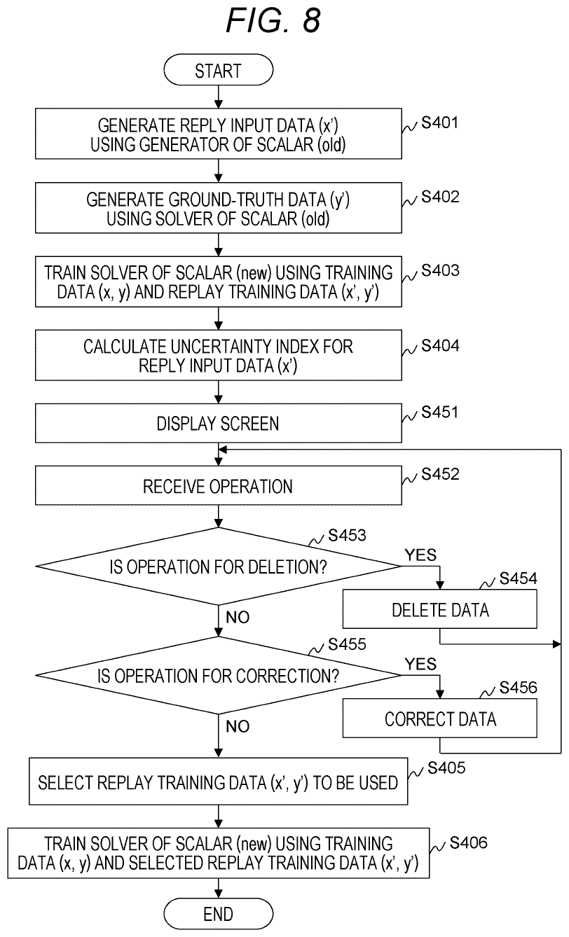

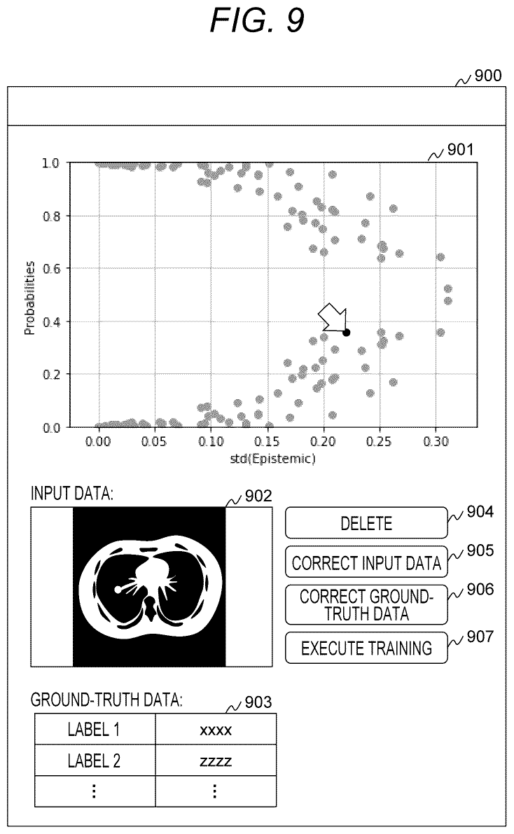

In the second embodiment, the method for training the solver 202 is partially different. FIG. 8 is a flowchart for explaining an example of the processing of training the solver 202, in the computer 100 according to the second embodiment. FIG. 9 is a diagram illustrating an example of a screen presented by the computer 100 according to the second embodiment.

The processing from step S401 to step S404 in the second embodiment is the same as that in the first embodiment.

After the processing in step S404 is executed, the training unit 111 presents a screen 900 (step S451), and waits for a user operation.

The screen 900 includes an index area 901, an input data area 902, a ground-truth data area 903, a delete button 904, a correct input data button 905, a correct ground-truth data button 906, and an execute training button 907.

An index area 901 is an area for displaying uncertainty indices of the replay input data (x′). In the index area 901 in FIG. 9, a graph in having the horizontal axis representing the uncertainty index and the vertical axis representing the probabilities of prediction result is displayed. One point corresponds to one piece of replay input data (x′). The user selects a piece of replay input data (x′) to be referred to, from the index area 901.

The input data area 902 is an area for displaying the replay input data (x′). The ground-truth data area 903 is an area for displaying the ground-truth data (y′) that is paired with the replay input data (x′).

The delete button 904 is an operation button for deleting the replay training data 301 including the replay input data (x′) from the data set.

The correct input data button 905 is an operation button for correcting the replay input data (x′). To correct data, a user can make an operation on the input data area 902 directly, or execute a preset correction process.

The correct ground-truth data button 906 is an operation button for correcting the ground-truth data (y′) that is paired with the replay input data (x′). To correct data, a user can make an operation on the ground-truth data area 903 directly, or to execute a preset correction process.

The execute training button 907 is an operation button for instructing execution of training of the solver 202 again, using the replay training data 301 selected by the user.

When an user operation is received (step S452), the training unit 111 determines whether the operation is an operation for deleting the replay training data 301 (step S453).

If the operation is an operation for deleting the replay training data 301, the training unit 111 deletes the designated replay training data 301 (step S454), and then transits to standby.

If the operation is not an operation for deleting the replay training data 301, the training unit 111 determines whether the operation is an operation for correcting either the replay input data (x′) or the ground-truth data (y′) (step S455).

If the operation is an operation for correcting either the replay input data (x′) or the ground-truth data (y′), the training unit 111 corrects the data in accordance with the correction operation (step S456), and then transits to standby.

Upon receiving an instruction for executing training, the training unit 111 executes the processing in steps S405 and S406. The processing in steps S405 and S406 in the second embodiment is the same as that in the first embodiment.

The processing of training the generator 201 in the second embodiment is the same as that of the first embodiment. The difference is that the training is performed using the corrected replay training data 301.

The user can delete and correct the replay training data (x′) by making a reference to the uncertainty index and the like. With this, a highly accurate model can be generated.

Note that the training data 300 may be corrected and deleted using the screen 900.

Note that the present invention is not limited to the embodiments described above, and includes various modifications thereof. For example, the embodiments have been described in detail to facilitate understanding of the present invention, and are not necessarily limited to those having all of the configurations described above. In addition, in relation to a part of the configuration according to each of the embodiments, another configuration may be added, the part may be deleted, or the part may be replaced with another.

In addition, some or all of the configurations, functions, the procedures or like explained above may be implemented as hardware, through designing of an integrated circuit, for example. In addition, the present invention may also be implemented by a program code of a piece of software that implements the functions according to the embodiments. In such a case, a storage medium in which the program code is recorded is provided to a computer, and a processor included in the computer reads the program code stored in the storage medium. In such a case, the program code itself read from the storage medium implements the functions of the embodiments described above, and the program code itself and the storage medium storing the program code constitute the present invention. As the storage medium for supplying such a program code, for example, a flexible disk, a CD-ROM, a DVD-ROM, a hard disk, a solid-state drive (SSD), an optical disk, a magneto-optical disk, a CD-R, a magnetic tape, a non-volatile memory card, a ROM, or the like is used.

Furthermore, the program code for implementing the functions described in the present embodiments may be implemented using a wide range of programs or script languages such as assembler, C/C++, perl, Shell, PHP, Python, and Java.

Furthermore, the program code of the piece of software implementing the functions according to the embodiments may be distributed over a network, and stored in a storage unit such as a hard disk or a memory of a computer, or a storage medium such as a CD-RW or a CD-R. The processor included in the computer may then read and execute the program code stored in the storage means or the storage medium.

In the embodiments described above, control lines and information lines illustrated are those considered to be necessary for the explanation, and are not necessarily representations of all of the control lines and the information lines in a product. All the configurations may be connected to each other.

1. A computer system comprising a computer including a processor, a storage device connected to the processor, and a connection interface connected to the processor, wherein
the computer system is configured to manage a first model that solves one or more tasks, and a second model that generates replay input data that is reproduction of input data included in training data used in training with a past task, and
the computer is configured to:
generate replay input data using the second model, upon receiving new training data that includes new input data and new ground-truth data related to a new task, and
generate replay training data including the replay input data and ground-truth data that is obtained by inputting the replay input data to the first model;
execute first training processing for updating the first model that is current to the first model adapted to solve the new task and the past task, using the new training data and the replay training data;
calculate an index representing uncertainty of data input to the first model based on an output obtained by inputting the replay input data to the first model resultant of updating;
select the replay training data to be used for training based on the index corresponding to the replay input data;
execute the first training process using the new training data and the replay training data having been selected; and
execute second training processing for updating the second model that is current to the second model enabled to generate replay input data that is reproductions of the new input data and the selected replay input data, using the new input data included in the new training data and the replay input data included in the selected replay training data.

2. The computer system according to claim 1, wherein the computer is further configured to:
generate display information for displaying the replay training data and the index for the replay input data after calculating the index for the replay input data; and
receive an operation of at least one of a correction instruction and a deletion instruction, the correction instruction and the deletion instruction being instructions for correcting and deleting the replay training data, respectively, via a screen displayed based on the display information.

3. The computer system according to claim 1, wherein the computer is further configured to:
calculate the index for the new input data based on an output obtained by inputting the new input data to the first model having been updated, when the index for the replay input data is calculated;
select the new training data to be used for training based on the index for the new input data;
execute the first training process using the new training data thus selected and the replay training data having been selected; and
execute the second training process using the new input data included in the new training data thus selected and the replay input data included in the replay training data having been selected.

4. A model training method configured to solve one or more tasks and executed by a computer system including a processor, a storage device connected to the processor, and a computer having a connection interface connected to the processor, wherein
the computer system is configured to manage a first model that solves one or more tasks, and a second model that generates replay input data that is reproduction of input data included in training data used in training with a past task, and
the model training method comprising:
a first step of causing the computer to generate replay input data using the second model, upon receiving new training data that includes new input data and new ground-truth data related to a new task;
a second step of causing the computer to generate replay training data including the replay input data and ground-truth data that is obtained by inputting the replay input data to the first model;
a third step of causing the computer to execute first training processing for updating the first model that is current to the first model adapted to solve the new task and the past task, using the new training data and the replay training data;
a fourth step of causing the computer to calculate an index representing uncertainty of data input to the first model based on an output obtained by inputting the replay input data to the first model resultant of updating;
a fifth step of causing the computer to select the replay training data to be used for training based on the index corresponding to the replay input data; and
a sixth step of causing the computer to execute the first training process using the new training data and the replay training data having been selected; and
a seventh step of causing the computer to execute second training processing for updating the second model that is current to the second model enabled to generate replay input data that is reproduction of the new input data and the replay input data, using the new input data included in the new training data and the replay input data included in the selected replay training data.

5. The model training method according to claim 4, wherein the fourth step includes:
a step of causing the computer to generate display information for displaying the replay training data and the index for the replay input data after calculating the index for the replay input data; and
a step of causing the computer to receive an operation of at least one of a correction instruction and a deletion instruction, the correction instruction and the deletion instruction being instructions for correcting and deleting the replay training data, respectively, via a screen displayed based on the display information.

6. The model training method according to claim 4, wherein
the fourth step includes a step of causing the computer to calculate the index for the new input data based on an output obtained by inputting the new input data to the first model having been updated;
the fifth step includes a step of causing the computer to select the new training data to be used for training based on the index for the new input data;
the sixth step includes a step of causing the computer to execute the first training process using the new training data thus selected and the replay training data having been selected; and
the seventh step includes a step of causing the computer to execute the second training process using the new input data included in the new training data thus selected and the replay input data included in the replay training data having been selected.
